(19) United States
(12) Patent Application Publication
(10) Pub. No.: US 2005/0050372 A1
(43) Pub. Date: Mar. 3, 2005

(54) Microcontroller unit controlling plurality of registers in accordance with precision of data to be operated, and compiler thereof

(75) Inventor: Masato Hagiwara, Hyogo (JP)

Correspondence Address: McDermott, Will & Emery LLP, 600 13th Street, N.W., Washington, DC, 20005-3096, US

(73) Assignee: RENESAS TECHNOLOGY CORP.

(21) Appl. No.: 10/929,535

(22) Filed: Aug. 31, 2004

(30) Foreign Application Priority Data
Sep. 2, 2003 (JP) 2003-310402(P)

(51) Int. Cl. G06F 1/32; G06F 1/26

(52) U.S. Cl. 713/320

(57) ABSTRACT

A precision storage unit stores the required precision of data. A register is formed of a 8-bit register. A decoder decodes the data precision stored by the precision storage unit. Control is provided of the power supply and clock supply to the registers in accordance with the decoded result of the decoder. Accordingly, power consumption of the microcontroller unit can be reduced.

### BACKGROUND OF THE INVENTION

1. Field of the Invention

The present invention relates to a microcontroller unit (abbreviated as “MCU” hereinafter) that carries out processing such as operation using a plurality of registers and the like, and more particularly, to an MCU controlling a plurality of registers and the like in accordance with the precision of data that is the subject of operation, and a compiler that compiles a program executed by such an MCU.

2. Description of the Background Art

In recent years, information communication equipment and household appliances mounted with a microprocessor have become widely available. Those having the feature of a computer including a microprocessor, a memory, and the like in one semiconductor chip are particularly called MCUs.

Data stored in the register of an MCU is generally subjected to processing such as operation at the precision determined by the hardware, independent of its precision. Even in the case where the precision of data that is the subject of operation is low, storage, transfer and the like of a plurality of upper bits that are not the subject of operation were inevitably performed. There was a problem that power is wasted. The invention disclosed in Japanese Patent Laying-Open No. 6-250818 is identified as related art.

The ALU (Arithmetic and Logic Unit) disclosed in Japanese Patent Laying-Open No. 6-250818 decodes the bit width to be operated, embedded in an instruction code, through an instruction decoder to provide control of whether to carry out 24-bit operation or 16-bit operation in response to the output of a decode result signal. Accordingly, operation of ALUs and registers that are not required to operate is suppressed.

The ALU disclosed in the aforementioned publication must have the bit width to be operated embedded in an instruction code. There was a problem that the type of specified operation, the number of bits of the operand, and the like will be reduced depending upon the instruction code. There was also a problem that power consumption cannot be reduced when an instruction not associated with an operation processing is executed.

### SUMMARY OF THE INVENTION

An object of the present invention is to provide a microcomputer unit that can have power consumption reduced by controlling power supply and the like to a register.

Another object of the present invention is to provide a compiler that can compile a program so as to reduce power consumption of a microcontroller unit by controlling power supply and the like towards a register in the microcontroller unit.

According an aspect of the present invention, a microcontroller unit includes a plurality of registers, and an operation unit that executes operation processing using the plurality of registers in accordance with a fetched instruction. Each of the plurality of registers includes a plurality of data storage units storing data of a plurality of bits in a predetermined unit. The microcontroller unit further includes a precision storage unit storing the precision of data that is required, and a control unit providing control of whether to store each input data in the plurality of data storage units in each of the plurality of registers in accordance with the data precision stored in the precision storage unit.

Accordingly, power consumption of the microcontroller unit can be reduced.

According to another aspect of the present invention, a microcontroller unit includes a plurality of registers, each storing data of a plurality of bits, a plurality of precision storage units, each provided corresponding to the plurality of registers to store information indicating the precision of data stored in a corresponding register, and an operation unit executing an operation using at least one of the plurality of registers in accordance with a fetched instruction, and executing an operation in a data width in accordance with the data precision in the precision storage unit corresponding to the used register.

Accordingly, power consumption of the microcomputer unit can be reduced.

According to a further aspect of the present invention, a compiler includes a compile processing unit to carry out a normal compile process on a program, and a code insert unit determining the precision required in the register used in a function in the program compiled by the compile processing unit, and inserting an instruction code that specifies a bit to which power is supplied and a bit to which power supply is suppressed in that register.

Accordingly, a program can be compiled so as to reduce power consumption of the microcontroller unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a schematic structure of an MCU according to a first embodiment of the present invention.

FIG. 2 is a block diagram of a schematic structure of a CPU core 1 in FIG. 1.

FIG. 3 is a block diagram to describe in further detail a power supply and clock control unit 14 in FIG. 2.

FIG. 4 is a diagram representing the relationship among a mode stored in a mode register 13, data precision based on 3-bit information stored in a precision storage unit 12, and power supply control signals a-d shown in FIG. 3.

FIG. 5 is a block diagram to describe in further detail a configuration of a 32-bit register 11 shown in FIG. 3.

FIG. 6 is a diagram to describe an operation of a selector 141.

FIGS. 7A-7C represent examples of a configuration of the selector of FIG. 5.

FIG. 8 represents an example of a configuration of power supply control circuits 110a, 111a and 111b.

FIG. 9 is a diagram to describe in further detail an operation unit 15 in FIG. 2.

FIG. 10 is a flow chart to describe an operation of an MCU according to the first embodiment.

FIG. 11 represents an example of a stream of instructions executed by an MCU 1 of the first embodiment.

FIG. 12 shows another example of a stream of instructions executed by MCU 1 in the first embodiment.

FIG. 13 is a block diagram of a schematic configuration of a CPU core according to a second embodiment of the present invention.

FIG. 14 is a block diagram of an example of a configuration of a compiler in the second embodiment.

FIG. 15 is a block diagram of an operation configuration of the compiler in the second embodiment.

FIG. 16 is a flow chart to describe the processing procedure of the compiler in the second embodiment.

FIG. 17 is a flow chart to describe in detail a power supply control code insert process of level 1 in steps S23 and S24 of FIG. 16.

FIG. 18 is a flow chart to describe in detail a power supply control code insert process of level 2 in step S25 of FIG. 16.

### DESCRIPTION OF THE PREFERRED EMBODIMENTS

First Embodiment

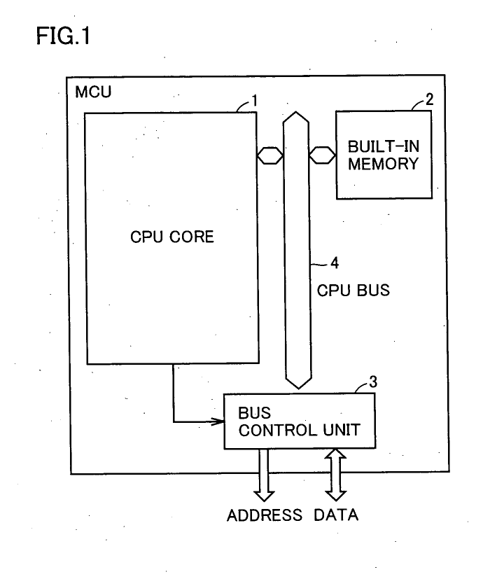

Referring to FIG. 1, an MCU according to a first embodiment of the present invention includes a CPU (Central Processing Unit) core 1, a built-in memory 2, and a bus control unit 3 that provides control of a CPU bus 4 and an external bus for access to built-in memory 2, an external memory, and the like.

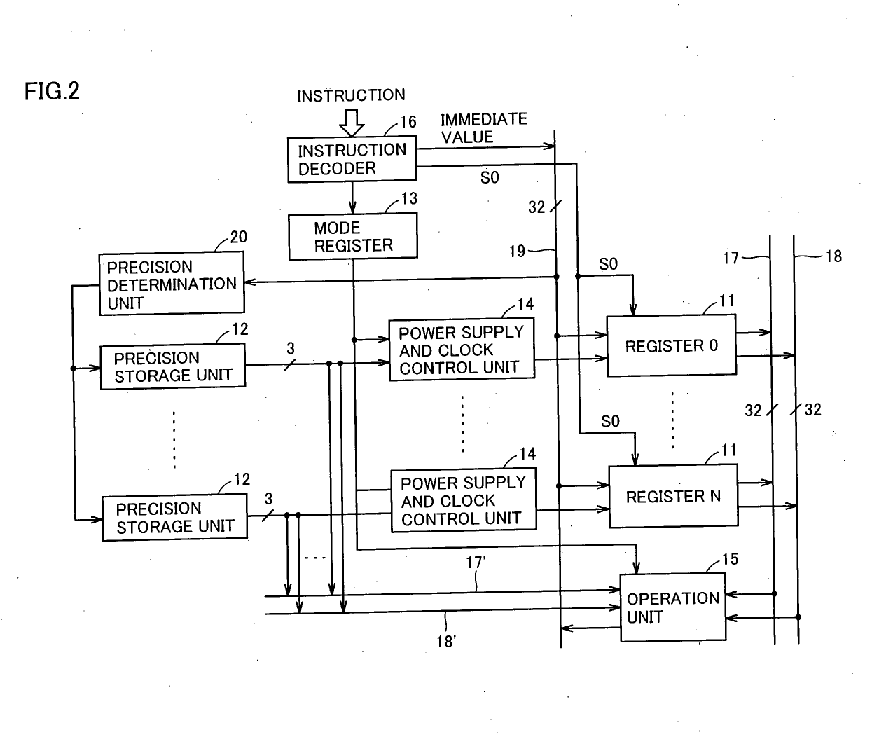

Referring to FIG. 2, CPU core 1 includes a plurality of registers 0-N (11), precision storage units 12 to store precision information of data, a mode register 13 in which the operation mode of the MCU is set, power supply and clock control units 14 providing control of the power supply and clock of registers 0-N (11) and the like, an operation unit 15, an instruction decoder 16 decoding a fetched instruction, and a precision determination unit 20 determining the data precision. Precision storage unit 12 and power supply and clock control unit 14 are provided for each of registers 0-N (11). Precision storage units 12 and mode register 13 are formed of a register or the like that allows reading/writing by CPU core 1.

Buses 17 and 18 each represent a data bus of 32 bits, through which data used in an operation by operation unit 15 is transferred from any of registers O-N. When data is to be stored into a memory, data is transferred via bus 17, and data is stored into a memory via CPU bus 4, for example.

Instruction decoder 16 sequentially decodes a fetched instruction to control each element in the CPU core to execute processing specified by the instruction. For example, a register that is used in the execution of an instruction is selected from registers 0-N. Furthermore, operation unit 15 is controlled so as to execute an operation specified by the operation instruction. Mode setting in mode register 13 is also performed in accordance with a certain instruction.

Bus 19 represents a data bus of 32 bits to transfer the operated result from operation unit 15 to the register that is to be used among registers O-N. When data is to be loaded from a memory, data is transferred from a memory via CPU bus 4 to be transferred to a specified register via bus 19 for loading.

Buses 17′ and 18′ each represent a bus of 3 bits to transfer and supply to operation unit 15 data of precision storage unit 12 corresponding to the register to which data is transferred via buses 17 and 18.

Precision determination unit 20 receives data transferred via bus 19 to determine the precision of data to be loaded to a register via bus 19. Specifically, data of 32 bits is divided into groups of one byte from the higher order to search through the bits in each byte to determine whether all the bits in the byte are 0 or 1. The manner of searching will be described for respective cases hereinafter.

(1) A search is conducted from the most significant byte of the 32-bit data. When the first byte in which all the bits therein are not 0 is found, the lower bytes including that byte found are taken as the data precision.

For example, consider the case where the data on bus 19 is 0x00 00 00 ff. All the bits in the upper 3 bytes are 0, and only all the bits in the least significant byte are not 0. Therefore, the least significant byte is identified. Thus, determination is made that the data corresponds to 8-bit precision.

Consider the case where the data on bus 19 is 0x0000 ffff. All the bits in the upper 2 bytes are 0, and not all the bits in the next byte are 0. Therefore, the third higher-order byte is identified. Thus, determination is made that the data corresponds to 16-bit precision.

Consider the case where the data on bus 19 is 0x01 ff ff 00. Not all the bits in the most significant byte are 0. Therefore, the most significant byte is identified. Thus, determination is made that the data corresponds to 32-bit precision.

(2) When all the bits in 32-bit data are 0, determination is made that the data corresponds to 0-bit precision.

(3) A search is conducted from the most significant byte of 32-bit data. When the first byte in which all the bits in the byte are not 1 is found, determination is made as set forth below depending upon whether the first bit in the byte found is 0 or 1:
i) When the first bit in the byte found is 1, that byte found is taken as the data precision.

For example, consider the case where the data on bus 19 is 0xff ff ff0 00. All the bits in the upper two bytes are 1, and not all the bits in the next byte are 1. Therefore, the third upper byte is identified. Since the first bit in that byte found is 1, determination is made that the data corresponds to 16-bit precision by the third upper byte in the search.
ii) When the first bit in the byte found is 0, the byte that is higher order than the byte found by one byte is taken as the data precision.

For example, consider the case where the data on bus 19 is 0xff ff ff 00. All the bits in the upper three bytes are 1, and not all the bits in the next byte are 1. Therefore, the least significant byte is identified. Since the first bit in that byte found is 0, determination is made that the data corresponds to 16-bit precision by the third upper byte.

(4) When all the bits in 32-bit data are 1, determination is made that the data corresponds to 8-bit precision.

In accordance with the precision determined by precision determination unit 20, data of the relevant data precision is stored in precision storage unit 12 corresponding to the register that is to be loaded. Selection of precision storage unit 12 as well as selection of the target register of loading is under control of an instruction decoder 16.

With regards to instructions decoded by instruction decoder 16, load instructions for loading data into a register includes the following types of instruction:
1) ldu instruction . . . instruction for loading unsigned 32-bit data from memory
2) lduh instruction . . . instruction for loading unsigned 16-bit data from memory
3) ldub instruction . . . instruction for loading unsigned 8-bit data from memory
4) ld instruction . . . instruction for loading signed 32-bit data from memory
5) ldh instruction . . . instruction for loading signed 16-bit data from memory
6) ldb instruction . . . instruction for loading signed 8-bit data from memory
7) ldi instruction . . . instruction for loading signed immediate value

The 32-bit data loaded by the ldu instruction or ld instruction is transferred occupying the entire bit width of data bus 19, and then stored in the specified register.

The 16-bit data loaded by the lduh instruction or ldh instruction is transferred over a width of the lower 16 bits of 32-bit data bus 19. The upper 16 bits of bus 19 are fixed to 0.

The 8-bit data loaded by the ldub instruction or ldb instruction is transferred over a width of the lower 8 bits of 32-bit data bus 19. The upper 24 bits of bus 19 are fixed to 0.

When an immediate value is loaded by the ldi instruction, specification can be made whether to set the immediate value as 16-bit data or 8-bit data. In the case of an immediate value of 16 bits, the data is transferred over the width of the lower 16 bits of 32-bit data bus 19. The upper 16 bits of bus 19 are fixed to 0. In the case of an immediate value of 8 bits, data is transferred over the width of the lower 8 bits of 32-bit data bus 19. The upper 24 bits of bus 19 are fixed to 0.

The data transfer path from a memory to a register is set forth below. Data transferred from built-in memory 2 of FIG. 1 passes through CPU bus 4 and data bus 19 of FIG. 2 to arrive at a predetermined register. When the memory is external to the MCU, data from the external memory passes through bus control unit 3, CPU bus 4 and data bus 19 of FIG. 2 to arrive at a predetermined register. When an immediate value is to be loaded, data is transferred from instruction decoder 16 to a specified register via data bus 19.

In any data loading operation, precision determination unit 20 determines the data precision when data is to be transferred via a data bus 19.

Store instructions storing data from a register to a memory includes the following types of instruction:
1) st instruction . . . instruction for storing 32-bit data
2) sth instruction . . . instruction for storing 16-bit data
3) stb instruction . . . instruction for storing 8-bit data

The data transfer path from a register to a memory is set forth below. Data is transferred from a specified one of registers 0-N to arrive at built-in memory 2 via data bus 17 or 18 and CPU bus 4 of FIG. 1. When the memory is external to the MCU, data from a specified one of registers 0-N passes through bus 17 or 18, CPU bus 4 of FIG. 1, and bus control unit 3 to arrive at the external memory.

Instruction decoder 16 outputs a signal S0 of an H level when the decoded instruction is a signed load instruction, and outputs signal S0 of an L level for other instructions.

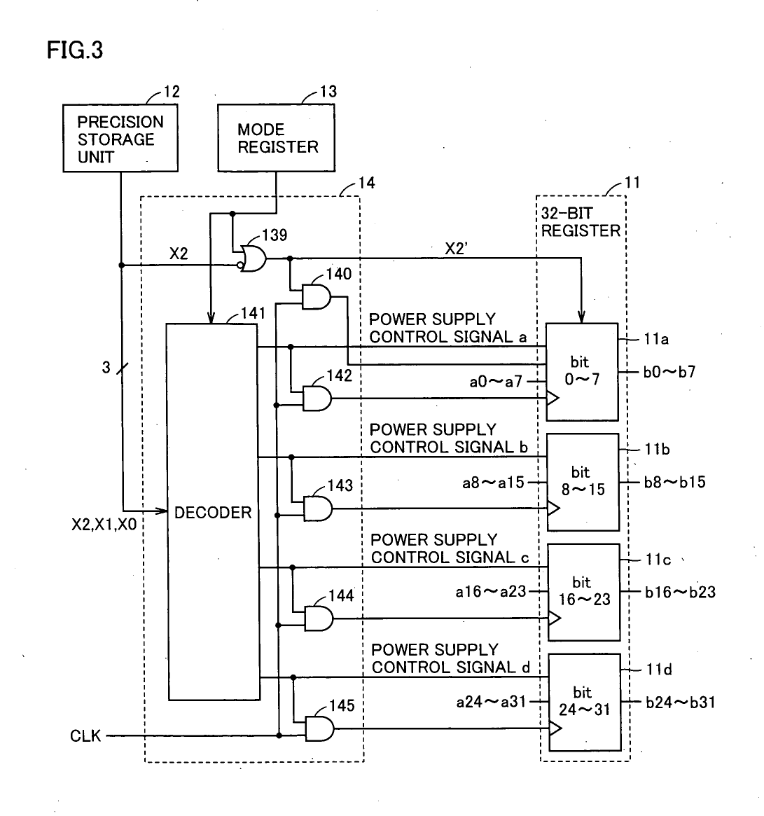

Referring to FIG. 3, power supply and clock control unit 14 includes a decoder 141 decoding data precision information held in precision storage unit 12, AND circuits 140 and 142-145 for controlling clock input to register 11 in accordance with the decoded result of decoder 141, and an OR circuit 139.

Precision storage unit 12 retains 3-bit information X2, X1 and X0. The 3-bit information indicates whether the data precision is 0 bit, 8 bits, 16 bits, 24 bits or 32 bits.

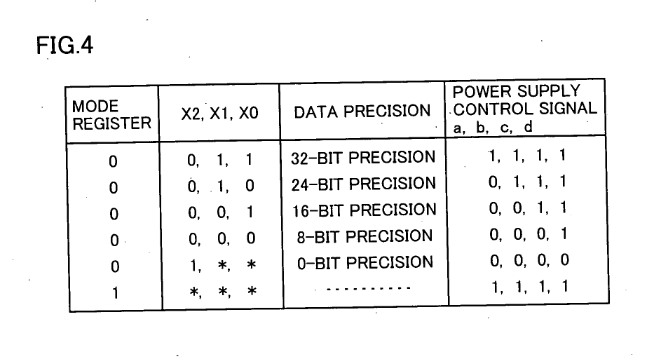

FIG. 4 corresponds to a table of the mode indicated in mode register 13, the data precision as to the 3-bit information stored in precision storage unit 12, and power supply control signals a-d of FIG. 3. The mode register value of 0 indicates a power save mode and the mode register value of 1 indicates a normal mode. The “*” character represents that an arbitrary value of either 0 or 1 is allowed.

When information X2, X1 and X0 stored in precision storage unit 12 are 0, 1, and 1, respectively, data corresponds to 32-bit precision. All power supply control signals a-d are output at an H level.

When information X2, X1 and X0 stored in precision storage unit 12 are 0, 1, and 0, respectively, data corresponds to 24-bit precision. Power supply control signal a is output at an L level, and power supply control signals b-d are output at an H level.

When information X2, X1 and X0 stored in precision storage unit 12 are 0, 0, and 1, respectively, data corresponds to 16-bit precision. Power supply control signals a-b are output at an L level, and power supply control signals c-d are output at an H level.

When information X2, X1 and X0 stored in precision storage unit 12 are 0, 0, and 0, respectively, data corresponds to 8-bit precision. Power supply control signals a-c are output at an L level, and power supply control signal d is output at an H level.

Information X2 of 1 stored in precision storage unit 12 indicates that the data corresponds to 0-bit precision, irrespective of other values. Power supply control signals a-d are all output at an L level.

OR circuit 139 of FIG. 3 takes the logical sum of an inversion of X2 stored in precision storage unit 12 and the value stored in mode register 13. AND circuit 140 takes the logical product of clock CLK and the output of OR circuit 139. The output of AND circuit 140 is employed as the clock signal of a most significant FF 112a in register 11a that will be described afterwards. Therefore, when in a power save mode and when precision storage unit 12 indicates 0-bit precision, the power supply of FF 112a is cut off through the output of OR circuit 139, and the clock to FF 112a is suppressed through the output from AND circuit 140.

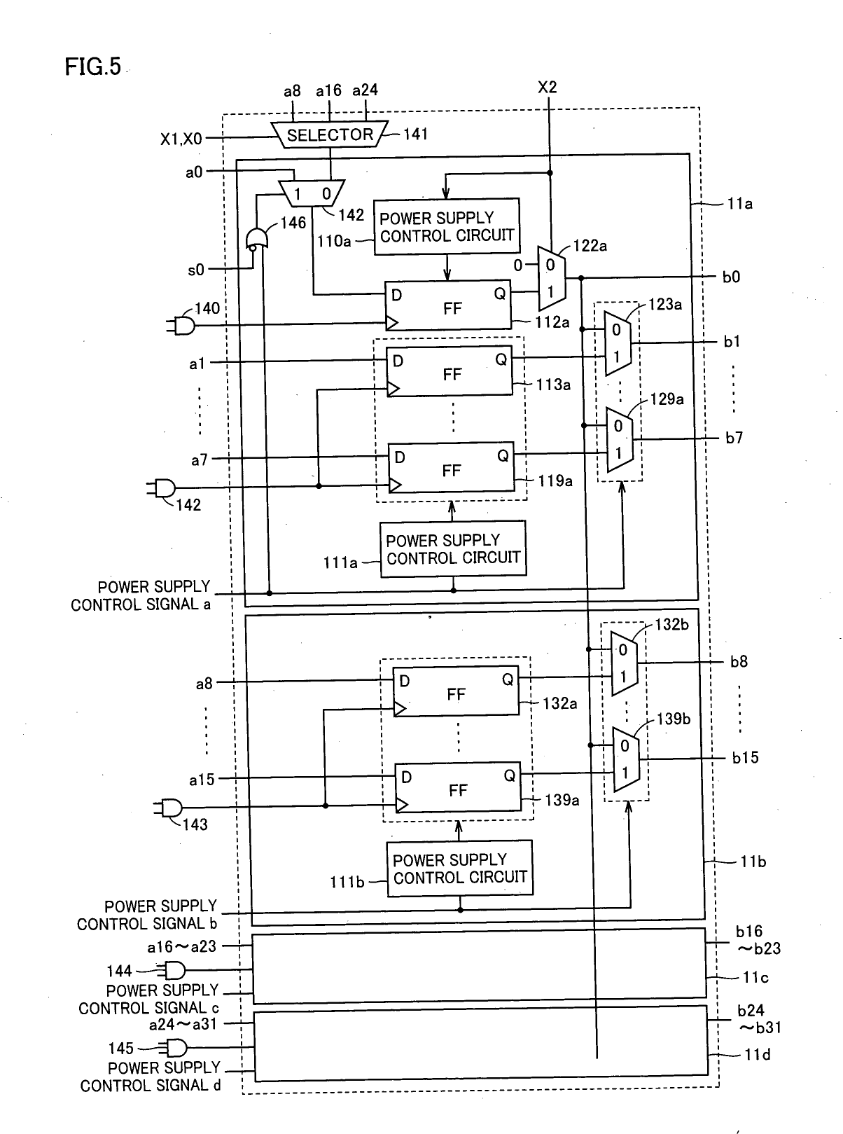

Referring to the block diagram of FIG. 5 representing a configuration of 32-bit register 11 in FIG. 3, a register 11a corresponding to the upper 8 bits (b0-b7) includes FFs 112a-119a, a power supply control circuit 110a controlling the power supply of FF 112a, a power supply control circuit 111a controlling the power supply of FFs 113a-119a, selectors 122a-129a, 141 and 142, and an OR circuit 143. A register 11b corresponding to the next 8 bits (b8-b15) includes a power supply control circuit 111b, FFs 132a-139a, and selectors 132b-139b.

Selector 122a selects and outputs 0 when signal X2′ is 0, and selects and outputs the output of FF 112a when the signal X2 is 1. Selectors 123a-129a select and output the output of selector 122a when power supply control signal a is 0, and select and output the outputs of FFs 113a-119a when power supply control signal a is 1.

Power supply control circuit 111a supplies power to FFs 113a-119a when power supply control signal a is at an H level, and suppresses power supply to FFs 113a-119a when power supply control signal a is at an L level. At this stage, the input of clock signals to FFs 113a-119a is also suppressed.

Power supply control circuit 110 allows power supply to FF 112a when signal X2′ is at an H level, i.e. mode register 13 is 1, or when precision storage unit 12 stores information indicating precision other than 0-bit precision, and suppresses power supply to FF 112a when signal X2 is at an L level. At this stage, input of a clock signal to FF 112a is also suppressed. When power supply to FF 112a is suppressed, all the other power supply control signals b-d are at an L level, and b0-b31 are all 0 in response to a 0 output from selector 122a.

Selectors 123a-129a select and output the contents of FFs 113a-119a when power supply control signal a is at an H level, and select and output the output of preceding selector 122a when power supply control signal a is at an L level. Thus, a sign bit can be output to all the bits in register 11a when power supply control signal a is at an L level, allowing sign extension.

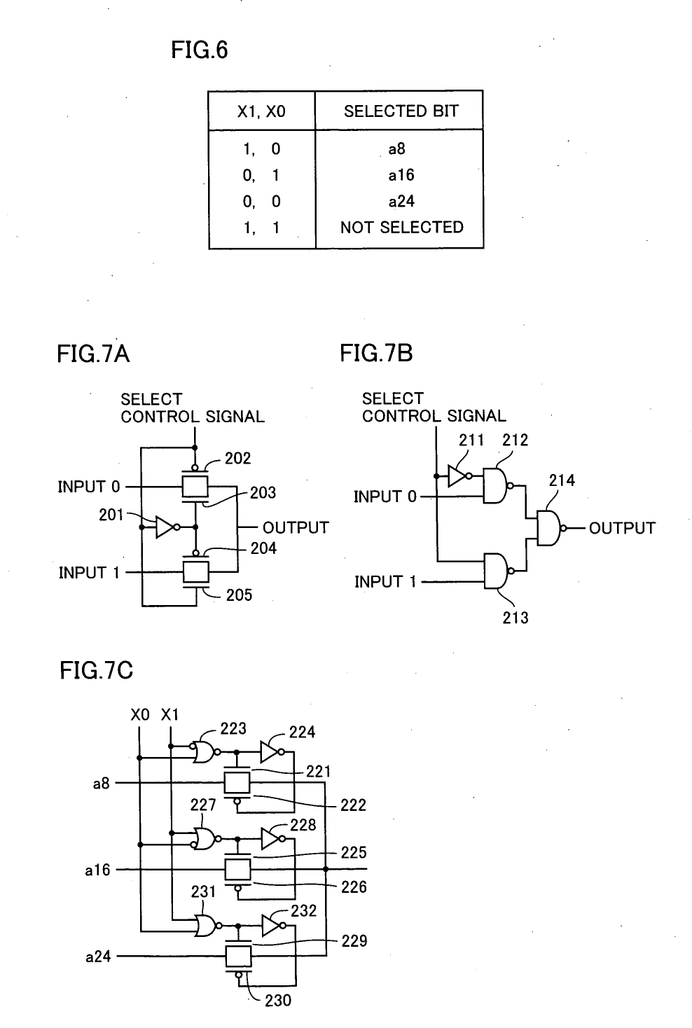

FIG. 6 is a diagram to describe the operation of selector 141. When signals X1 and X0 stored in precision storage unit 12 are 1 and 0, respectively, selector 141 selects and outputs “a8” that is the 24th lower-order bit of the 32-bit data. When signals X1 and X0 stored in precision storage unit 12 are 0 and 1, respectively, selector 141 selects and outputs “a16” that is the 16th lower-order bit of the 32-bit data. When signals X1 and X0 stored in precision storage unit 12 are 0 and 0, respectively, selector 141 selects and outputs “a24” that is the 8th lower-order bit of the 32-bit data.

OR circuit 146 takes the logical sum of power supply control signal a and an inversion of signal S0. The output of OR circuit 146 is taken as the select control signal of selector 142.

When the data precision of the data loaded to the register is 32 bits, power supply control signal a is output at an H level. Selector 142 selects and outputs “a0” that is the most significant bit of that data. As a result, FF 112a stores “a0”.

When the data precision of the data loaded to the register according to a signed load instruction is 8 bits, signals X1 and X0 indicate 0 and 0, respectively. Therefore, selector 141 selects “a24” that is the 8th lower-order bit of the data. Further, OR circuit 146 outputs an L level, whereby selector 142 selects and outputs “a24”. As a result, FF 112a stores “a24”. By selectors 122a-129a and 132b-139b, and the selection of the register in corresponding registers 11c and 1d, “a24” is reflected to b0-b23. The remaining b24-b31 take the values of a24-a31.

When the data precision of the data loaded to the register by a signed load instruction is 16 bits, signals X1 and X0 indicate 0 and 1, respectively. Selector 141 selects “a16” that is the 16th lower-order bit of the data. Further, OR circuit 146 outputs an L level, whereby selector 142 selects and outputs “a16”. As a result, FF 112a stores “a16”. At this stage, “a16” is reflected to b0-b15 by of selectors 122a-129a, 132b-139b, and the selection of the register in corresponding registers 11c and 11d. The other b16-b31 take the values of a16-a31.

When the data precision of the data loaded into the register by a signed load instruction is 24 bits, signals X1 and X0 indicate 1 and 0, respectively. Selector 141 selects “a8” that is the 24th lower-order bit of the data. Further, OR circuit 146 outputs an L level, whereby selector 142 selects and outputs “a8”. As a result, FF 112a stores “a8”. At this stage, “a8” is reflected to b0-b7 by selectors 120a-129a and 132b-139b, and also the selection of the register in corresponding registers 11c and 11d. The other b8-b31 take the values of a8-a31.

When the data precision of data loaded to the register by an instruction other than the signed load instruction (for example, an operation instruction or an unsigned load instruction using operation unit 15) corresponds to 8 bits, OR circuit 146 outputs an H level. Selector 142 selects and outputs the most significant bit a0. As a result, FF 112a stores “a0”. At this stage, “a0” is reflected to b0-b23 by selectors 122a-129a and 132b-139b, and also the selection of the register in corresponding registers 11c and 1d. The other b24-b31 take the values of a24-a31.

When the data precision of data loaded to a register by an instruction other than a signed load instruction corresponds to 16 bits, OR circuit 146 outputs an H level. Selector 142 selects and outputs the most significant bit “a0”. As a result, FF 112a stores “a0”. At this stage, “a0” is reflected to b0-b15 by selectors 122a-129a and 132b-139b, and also the selection of the register in corresponding registers 11c and 11d. The other b16-b31 take the values of a16-a31.

When the data precision of data loaded into a register by an instruction other than a signed load instruction corresponds to 24 bits, OR circuit 146 outputs an H level. Selector 142 selects and outputs the most significant bit “a0”. As a result, FF 112a stores “a0”. At this stage, “a0” is reflected to b0-b7 by selectors 122a-129a and 132b-139b, and also the selection of the register in corresponding registers 11c and 11d. The other b8-b31 take the values of a8-a31.

FIGS. 7(A) and 7(B) represent examples of a configuration of the selector shown in FIG. 5 (excluding selector 141). The selector of FIG. 7A includes an inverter 201 and transistors 202-205. When the select control signal is at an L level, transistors 202 and 203 are ON whereas transistors 204 and 205 are OFF. Therefore, input 0 is selected. When the select control signal is at an H level, transistors 204 and 205 are ON, whereas transistors 202 and 203 are OFF. Therefore, input 1 is selected.

The selector of FIG. 7B includes an inverter 211, and NAND circuits 212-214. When the select control signal is at an L level, NAND circuit 212 outputs an inverted version of input 0, whereas NAND circuit 213 outputs an H level. Therefore, NAND circuit 214 outputs input 0. When the select control signal is at an H level, NAND circuit 212 outputs an H level, whereas NAND circuit 213 outputs an inverted version of input 1. Therefore, NAND circuit 214 outputs input 1.

Referring to FIG. 7C, selector 141 includes transistors 221, 222, 225, 226, 229 and 230, NOR circuits 223, 227 and 231, and inverters 224, 228 and 232.

When signals X1 and X0 are 1 and 0, respectively, transistors 221 and 222 are ON, whereas transistors 225, 226, 229 and 230 are OFF. Therefore “a8” is selected and output.

When signals X1 and X0 are 0 and 1, respectively, transistors 225 and 226 are ON, whereas transistors 221, 222, 229 and 230 are OFF. Therefore, “a8” is selected and output.

When signals X1 and X0 are 0 and 0, respectively, transistors 229 and 230 are ON, whereas transistors 221, 222, 225 and 226 are OFF. Therefore, “a24” is selected and output.

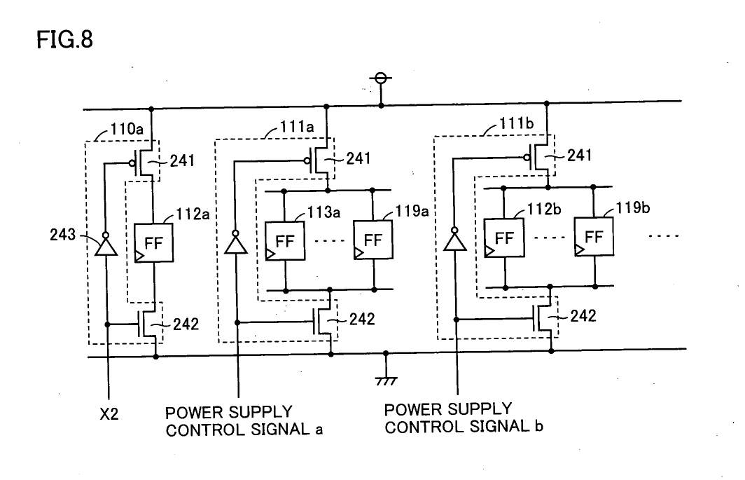

FIG. 8 shows an example of a configuration of power supply control circuits 110a, 111a and 111b, each having the same configuration. As a representative example, power supply control circuit 110a includes transistors 241 and 242, and an inverter 243. When signal X2′ is at an L level, transistors 241 and 242 are OFF. Power supply to FF 112a is suppressed. When signal X2′ is at an H level, transistors 241 and 242 are ON, whereby power is supplied to FF 112a.

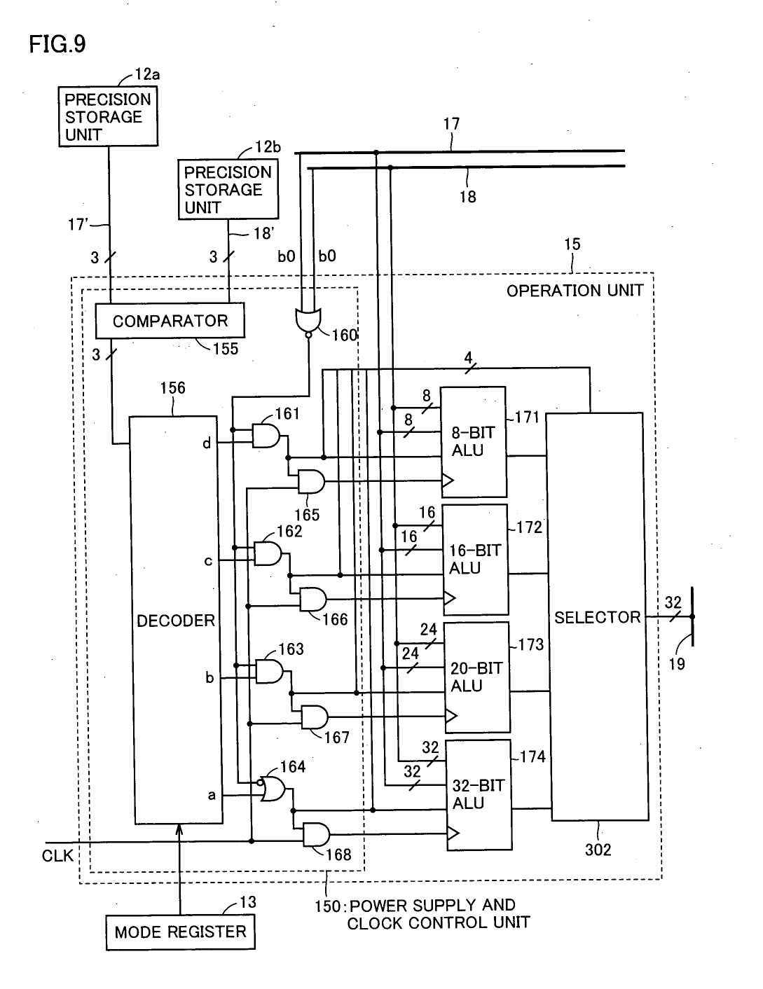

Referring to FIG. 9, operation unit 15 of FIG. 2 includes a power supply and clock control unit 150, an 8-bit ALU 171, a 16-bit ALU 172, a 24-bit ALU 173, a 32-bit ALU 174, and a selector 302.

Precision storage unit 12a stores the data precision corresponding to the first source register that applies data onto data bus 17. Precision storage unit 12b stores the data precision corresponding to the second source register that applies data onto data bus 18.

Operation unit 15 performs an operation specified by an operation instruction using data in the register selected as the operand of the operation instruction. Power supply and clock control unit 150 provided therein determines the data width of the operation carried out by operation unit 15 in accordance with the data precision of data on one or both of buses 17 and 18.

Power supply and clock control unit 150 includes a comparator 155 comparing the value stored in precision storage unit 12a with the value stored in precision storage unit 12b, a decoder 156, a NOR circuit 160, and AND circuits 161-168.

Comparator 155 compares the data precision stored in precision storage units 12a and 12b to select and output the larger data precision. When the data precision is equal, that data precision is output.

Decoder 156 decoders the data precision output from comparator 155. In response to the decoded result, only power supply control signal a is output as an H level and the other power supply control signals are output at an L level when the data precision is 32 bits. When the data precision is 24 bits, only power supply control signal b is output at an H level, and the other power supply control signals are output at an L level. When the data precision is 16 bits, only power supply control signal c is output at an H level, and the other power supply control signals are output at an L level. When the data precision is 8 bits, only power supply control signal d is output at an H level, and the other power supply control signals are output at an L level.

8-bit ALU 171 carries out an arithmetic/logic operation of the lower 8 bits in each of buses 17 and 18 in synchronization with clock CLK when AND circuit 161 provides an output of an H level. When AND circuit 161 provides an output of an L level, power supply to 8-bit ALU 171 is suppressed. Additionally, AND circuit 165 provides an output of an H level to suppress supply of clock CLK. Thus, 8-bit ALU 171 is inhibited of its operation.

16-bit ALU 172 performs an arithmetic/logic operation of the lower 16 bits in each of buses 17 and 18 in synchronization with clock CLK when AND circuit 162 provides an output of an H level. When AND circuit 162 provides an output of an L level, power supply to 16-bit ALU 172 is suppressed. Additionally, AND circuit 166 provides an output of an L level, whereby supply of clock CLK is suppressed. Thus, 16-bit ALU 172 is inhibited of its operation.

24-bit ALU 173 performs an arithmetic/logic operation of the lower 24 bits on each of buses 17 and 18 in synchronization with clock CLK when AND circuit 163 provides an output of an H level. When AND circuit 163 provides an output of an L level, power supply to 24-bit ALU 173 is suppressed. Additionally, AND circuit 167 provides an output of an L level, whereby supply of clock CLK is suppressed. Thus, 24-bit ALU 173 is inhibited of its operation. 32-bit ALU 174 performs an arithmetic/logic operation of 32 bits on each of buses 17 and 18 in synchronization with clock CLK when OR circuit 164 provides an output of an H level. When OR circuit 154 provides an output of an L level, power supply to 32-bit ALU 174 is suppressed. Additionally, AND circuit 168 provides an output of an L level, whereby supply of clock CLK is suppressed. Thus, 32-bit ALU 174 is inhibited of its operation.

NOR circuit 160 takes the NOR operation on the most significant bit “b0” of each of buses 17 and 18. Specifically, when the most significant bit b0 of at least one of buses 17 and 19 is 1, NOR circuit 160 outputs an L level. In response, AND circuits 161-163 and 165-167 provide an output of an L level. Supply of power and clock to 8-bit ALU 171, 16-bit ALU 172, and 24-bit ALU 173 is suppressed. Furthermore, OR circuit 164 provides an output of an H level, so that supply of power and clock to 32-bit ALU 174 is effected. For example, consider the operation of signed data ff ff ff ff+00 00 00 01. Although the proper operation result is 00 00 00 00 (value 0), the result would be output as 100 including the carry when operation is performed by 8-bit ALU 171. Since it is difficult to discriminate this operation result from the 0 value, operation is performed by 32-bit ALU 174.

When the most significant bit b0 on buses 17 and 18 are both 0, NOR circuit 160 provides an output of an H level. Accordingly, an ALU is selected in accordance with the bit precision output from comparator 155, and operation is performed by the selected ALU. Specifically, when the data corresponds to 8-bit precision, operation is performed by 8-bit ALU 171. When the data corresponds to 16-bit precision, operation is performed by 16-bit ALU 172. When the data corresponds to 24-bit precision, operation is performed by 24-bit ALU 173. When the data corresponds to 32-bit precision, operation is performed by 32-bit ALU 174.

Selector 302 selects and outputs the operated result carried out by an ALU in accordance with the outputs of AND circuits 161-164. Specifically, when 32-bit ALU 174 is selected, the operation output of 32 bits is applied to all the bits on 32-bit bus 19.

When 24-bit ALU 173 is selected, the operation result of 25 bits including the carry are applied to the lower 25 bits on 32-bit bus 19. The upper 7 bits are fixed to 0.

When 16-bit ALU 172 is selected, the operation result of 17 bits including the carry is applied to the lower 17 bits of 32-bit bus 19. The upper 15 bits are fixed to 0. When 8-bit ALU 171 is selected, the operation result of 9 bits including the carry is applied to the lower 9 bits of 32-bit bus 19. The upper 23 bits are fixed to 0.

ALUs 171, 172, 173 and 174 of 8 bits, 16 bits. 24 bits and 32 bits, respectively, perform arithmetic operations such as addition and subtraction as well as logical operations such as logical sums and logical products.

By determining the data width of operation in accordance with the data precision stored in precision storage units 12a and 12b to conduct an operation based on the identified data width, power consumption can be reduced. When the data precision corresponds to 8 bits, the operation result is the same regardless of whether the operation is carried out in 32-bit width or 8-bit width. Therefore, the operation is to be carried out based on the 8-bit width that consumes less power.

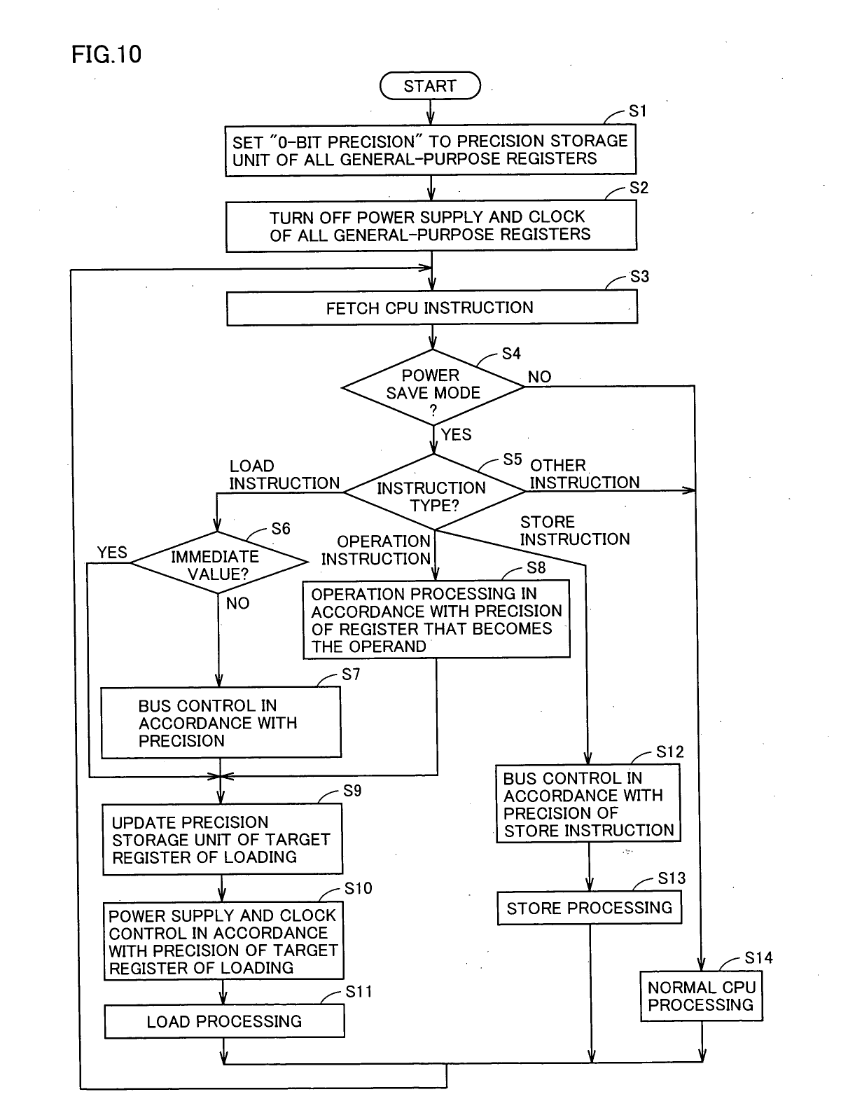

FIG. 10 is a flow chart to describe the operation of the MCU of the first embodiment. CPU core 1 sets 0 in precision storage unit 12 in all the general-purpose registers (S1), and suppresses the supply of power and clock to the FF in the general-purpose registers (S2).

CPU core 1 fetches an instruction from built-in memory 2, or from an external memory via bus control unit 3 (S3). CPU core 1 refers to mode register 13 to identify whether the mode is a power save mode or not (S4). When not in a power save mode (S4, NO), CPU core 1 carries out normal processing (S 14). Then, control returns to step S3 to repeat the subsequent process.

When in a power save mode (S4, YES), CPU core 1 identifies the type of the fetched instruction (S5). When the fetched instruction is a load instruction (S5, load instruction), determination is made whether the load corresponds to an immediate value, or from a memory (S6). In the case of loading of an immediate value (S6, YES), control proceeds to step S9. When the load is from a memory (S6, NO), bus control unit 3 is controlled in accordance with the precision (S7). Then, control proceeds to step S9.

When the fetched instruction is an operation instruction (S5, operation instruction), CPU core 1 performs operation processing in accordance with the precision of the register that becomes the operand (S8). Then, control proceeds to step S9.

At step S9, CPU core 1 updates precision storage unit 12 of the target register of loading. Control of power supply and clock supply is provided in accordance with the precision of the register that is the destination of loading (S10). A loading process is carried out. Then, control returns to step S3 to repeat the subsequent process.

When the fetched instruction is a store instruction (S5, store instruction), CPU core 1 provides control of bus control unit 3 in accordance with the precision of the store instruction (S12). A storing process is carried out (S13). Then, control returns to step S3 to repeat the subsequent process.

When the fetched instruction is not any of a load instruction, operation instruction, and store instruction (S5, other instruction), normal processing is carried out (S14). Then, control returns to step S3 to repeat the subsequent process.

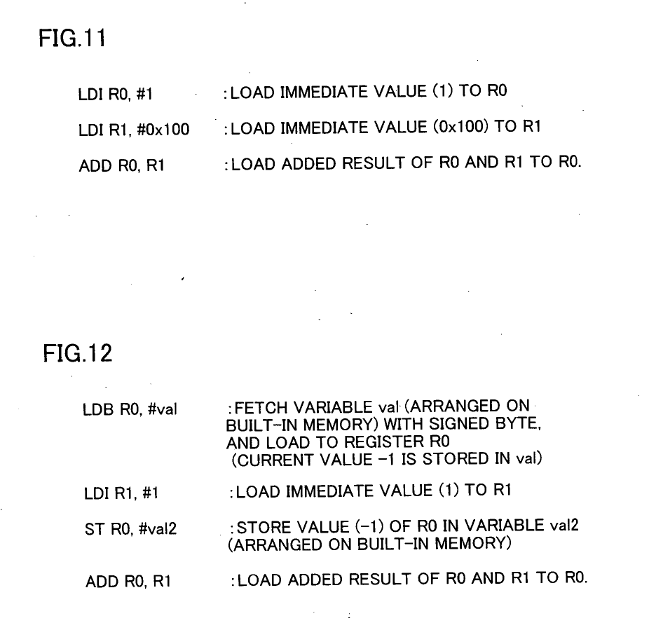

FIG. 11 shows an example of a stream of instructions executed by MCU 1 of the first embodiment. The process of this stream of instructions will be described with reference to the flow chart of FIG. 10. First, CPU core 1 sets “0-bit precision” at all precision storage units 12 (S1), whereby power supply and clock supply to all the FFs in the general-purpose registers are suppressed (S2). Then, CPU core 1 fetches the first instruction “LDI R0, #1” (S3).

Then, CPU core 1 refers to mode register 13 to identify that the power save mode is currently set (S4, YES). Since the fetched instruction is of a load instruction type (S6, load instruction), determination is made whether this load instruction corresponds to an immediate value, or a load instruction from a memory (S6). Since the fetched instruction is a load instruction of an immediate value (S6, YES), and the immediate value to be loaded into register R0 is 1, 0 indicating 8-bit precision is set in precision storage unit 12 (S9). Accordingly, power supply and clock supply to all FFs other than the lower 8 bits (bits24-b31) and the most significant bit (bit0) of register R0 are suppressed (S110).

CPU core 1 loads the immediate value of 1 to the lower 8 bits in register RO (Si 1). Then, control returns to step S3.

CPU core 1 fetches the next instruction “LDI RI, #0x100” (S3). CPU core 1 refers to mode register 13 to identify that the power save mode is currently set (S4, YES). Since the fetched instruction is of a load instruction type (S5, load instruction), determination is made whether this load instruction corresponds to a load instruction of an immediate value, or a load instruction from a memory (S6). Since the fetched instruction corresponds to loading of an immediate value (S6, YES), and the immediate value to be loaded to register RO is “0x1100”, 1 representing 16-bit precision is set at precision storage unit 12 (S9). Accordingly, power supply and clock supply to the FFs other than the lower 16 bits (bits b16-b31) and the most significant bit (bit0) of register R0 are suppressed (S10).

CPU core 1 loads immediate value 0x100 to the lower 16 bits in register R0 (S11). Then, control returns to step S3.

CPU core 1 fetches the last instruction “ADD R0, R1” (S3). CPU core 1 refers to mode register 13 to identify that a power save mode is currently set (S4, YES).

Since the type of the fetched instruction corresponds to an operation instruction (S5, operation instruction), an addition process of 16 bits is carried out in accordance with the precision of registers R0 and R1 that become operands (S8). Since power and clock are not supplied to the FF of bit 1-bit 23 in register R0, the sign bit (bit0) of 0 is read out to bits b16-b23 when the value of register R0 is read out in 16 bits.

Since the value to be loaded to register R0 (result of addition) is 0x101, CPU core 1 sets 1 indicating 16-bit precision in precision storage unit 12 (S9). Accordingly, power supply and clock supply to all the FF other than the lower 16 bits (bits b16-b31) and the most significant bit (bit0) of register R0 are suppressed (S10).

CPU core 1 loads 0x101 to the lower 16 bits of register R0 (S11). Then, control returns to step S3.

FIG. 12 shows another example of a stream of instructions executed by MCU 1 of the first embodiment. The process of this stream of instructions will be described with reference to the flow chart of FIG. 10. CPU 1 sets. “0-bit precision” in precision storage units 12 of all the general-purpose register (S1). Supply of power and clock to all the FF in the general-purpose register is suppressed (S2). Then, CPU core 1 fetches the first instruction “LDB R0, #val” (S3).

CPU core 1 refers to mode register 13 to identify that a power save mode is currently set (S4, YES). Since the fetched instruction is of a load instruction type (S5, load instruction), determination is made whether this load instruction corresponds to an immediate value, or is a load instruction from a memory (S6). Since the fetched instruction corresponds to a load instruction from a memory (S6, NO), and data of 8 bits is to be loaded from built-in memory 2, bus control unit 3 suppresses power supply and clock supply to all the bits other than the lower 8 bits on CPU bus 4 (S7). A signed 8-bit variable val of “0xff” is output from built-in memory 2.

Since the value to be loaded to register RO is 0xff, CPU core 1 sets 0 indicating 8-bit precision in precision storage unit 12 (S9). Accordingly, supply of power and clock to all the FFs other than the lower 8 bits (bit24-b31) and the most significant bit (bit0) in register R0 is suppressed (S10).

CPU core 1 loads value “0xff” to the lower 8 bits in register R0 (S1). At this stage, the value of bit24 is loaded to sign bit bit0 at the same time. Then, control returns to step S3.

CPU core 1 fetches the next instruction “LDI R1, #1” (S3). CPU core 1 refers to mode register 13 to identify that a power save mode is currently set (S4, YES). Since the fetched instruction is of a load instruction type (S5, load instruction), determination is made whether this load instruction corresponds to an immediate value, or a load instruction from a memory (S6). Since the fetched instruction is a load instruction of an immediate value (S6, YES), and the immediate value to be loaded to register R1 is 1, 0 indicating 8-bit precision is set in precision storage unit 12 (S9). Accordingly, supply of power and clock to all the FFs other than the lower 8 bits (bit24-b31) and the most significant bit (bit0) is suppressed (S10).

CPU core 1 loads immediate value 1 to the lower 8 bits in register R1 (S1). Then, control returns to step S3.

CPU 1 fetches the next instruction “ST R0, #val2” (S3). CPU core 1 refers to mode register 13 to identify that a power save mode is currently set (S4, YES). Since the fetched instruction is of a store instruction type (S5, store instruction) corresponding to 32 bits, bus control unit 3 is controlled so as to supply power and clock of all the 32 bits of CPU bus 4 (S12). Then, CPU core 1 outputs the value of register R0 onto CPU bus 4.

Since supply of power and clock to all the FFs other than the lower 8 bits and the sign bit in register R0 is suppressed, sign bit 1 is output to the bits other than the lower 8 bits. As a result, “−1(0xffffffff)” of 32 bits is output onto CPU bus 4. This value stored in variable val2 (S 13). Then, control returns to step S3.

CPU core 1 fetches the last instruction “ADD R0, R1” (S3). CPU core 1 refers to mode register 13 to identify that a power save mode is currently set (S4, YES). Since the fetched instruction is of an operation instruction type (S5, operation instruction), an addition operation of 32 bits is carried out in accordance with the precision of registers R0 and R1 that become the operand and the value in the sign bit (S8).

Since the value to be loaded to register R0 is “0(−1+1)”, CPU core 1 sets 0 indicating 8-bit precision in precision storage unit 12 (S9). Accordingly, the precision of register R0 corresponds to 0-bit precision. Supply of both power and clock is suppressed with respect to all the FFs shown in FIG. 5 (S10). Since all the selectors excluding selectors 141 and 142 select the 0 side, outputs b0-b31 all take the value of 0 (S11).

By using a flash memory, an SRAM (Static Random Access Memory) backed up, or the like as 32-bit register 11 in the present embodiment, power supply can be suppressed in all cases other than when access to the register is required. Such memories are called non-volatile memories.

In the present embodiment, information indicating whether the MCU is in a power save mode or not is stored in mode register 13. Alternatively, the mode can be switched directly by providing a dedicated instruction to switch between a power save mode and the normal mode, and inserting such a dedicated instruction into the program.

Although supply of both power and clock is suppressed in the present embodiment, supply of either one of the power and clock may be suppressed instead. Furthermore, a selector can be provided that selects the input of data to be loaded or the feedback of the output of the FF to provide the selected one to the input of the relevant FF. By selecting the output of the FF when the content of the FF is not to be updated, power consumption can be reduced.

Although a plurality of ALUs 171-174 are provided and an appropriate ALU to be used in the operation is selected therefrom as shown in FIG. 9, a configuration may be employed in which only one ALU is provided, and suppress the operation of the bit portion that, is not required in the operation in that ALU in accordance with the data precision of the operation.

In accordance with MCU 1 of the first embodiment, power consumption of MCU 1 can be reduced since supply of power and clock to the FF in the register is controlled in accordance with the value in precision storage unit 12 provided in each register.

Since power is constantly supplied to the FF that stores the value of the most significant bit b0 (sign bit) for all bit precisions other than the 0-bit precision, and a value identical to that of the sign bit is output from the register that is inhibited of power supply, sign extension can be effected readily.

Second Embodiment

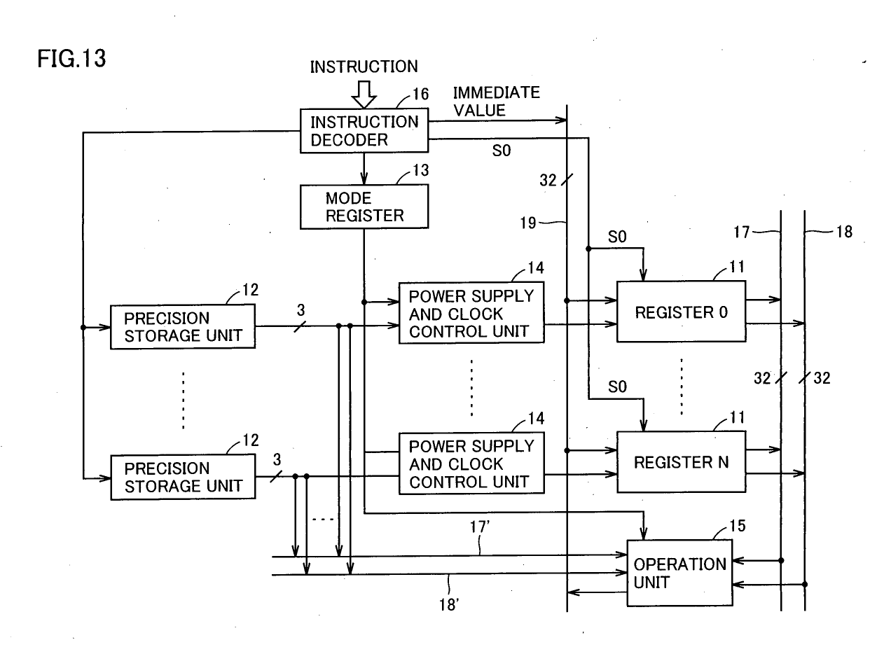

FIG. 13 is a block diagram of a schematic structure of a CPU core according to a second embodiment of the present invention. The CPU core of FIG. 13 differs from the CPU core of the first embodiment shown in FIG. 2 in that precision determination unit 20 is removed, and the data precision is set at precision storage unit 12 by instruction decoder 16 decoding a dedicated instruction that will be described afterwards. The data precision is set at precision storage unit 12. Therefore, detailed description of corresponding configuration and feature will not be repeated.

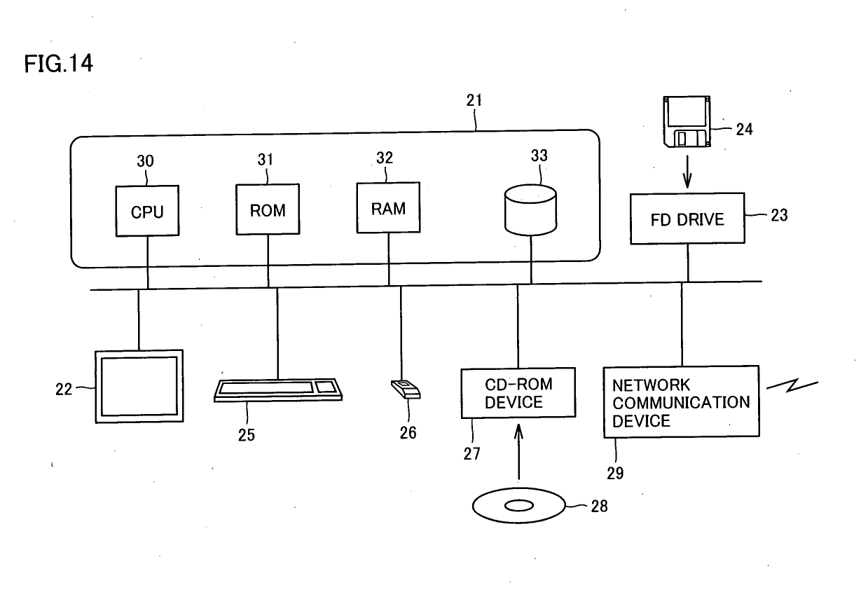

Referring to FIG. 14, a compiler of the second embodiment includes a computer body 21, a display device 22, an FD drive 23 in which an FD (Flexible Disk) 24 is loaded, a keyboard 25, a mouse 26, a CD-ROM device 27 in which a CD-ROM (Compact Disk-Read Only Memory) 28 is loaded, and a network communication device 29.

A program that compiles the program (referred to as “compile program” hereinafter) is supplied through a recording medium such as FD 24 or CD-ROM 28. By executing the compile program through computer unit 21, the program is compiled. The compile program may be supplied from another computer via network communication device 29.

Computer body 21 includes a CPU (Central Processing Unit) 30, a ROM (Read Only Memory) 31, a RAM (Random Access Memory) 28, and hard disk 33. CPU 30 carries out procedures based on data input/output with respect to display device 22, FD drive 23, keyboard 25, mouse 26, CD-ROM device 27, network communication device 29, ROM 31, RAM 32 or hard disk 33. The compile program recorded in FD24 or CD-ROM 28 is stored by CPU 30 into hard disk 33 via FD drive 22 or CD-ROM device 27. CPU 30 has the program compiled by appropriately loading and executing a compile program from hard disk 33 to RAM 32.

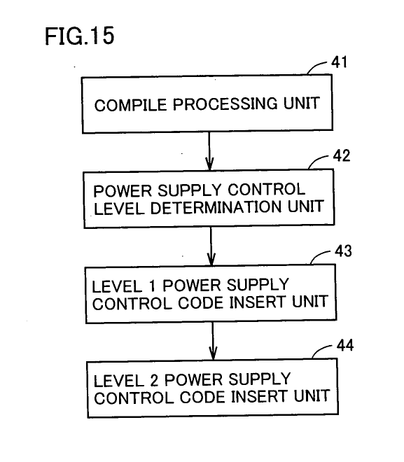

FIG. 15 is a block diagram showing an operation configuration of the compiler of the second embodiment. The compiler includes a compile processing unit 41 to carry out normal compile processing, a power supply control level determination unit 42 determining the control level of power supply, a level 1 power supply control code insert unit 43 inserting a power supply control code when the level of power supply control is level 1, and a level 2 power supply control code insert unit 44 inserting a power supply control code when the power supply control level is level 2.

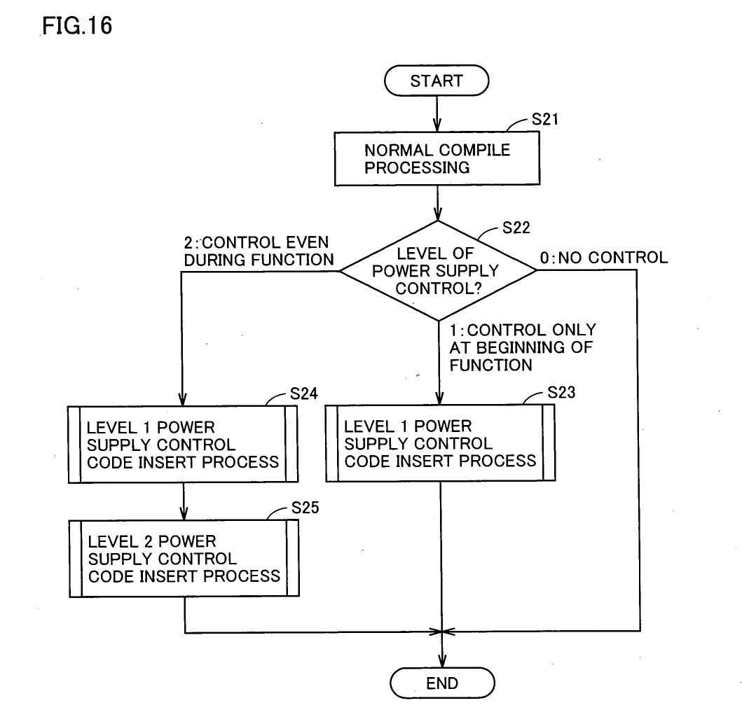

FIG. 16 is a flow chart to describe the procedure of the compiler in the second embodiment. First, compile processing unit 41 performs the normal compile processing (S21). This compile processing is a well known process carried out by a general compiler. Therefore, detailed description thereof will not be provided here.

Power supply control level determination unit 42 determines the level of power supply control specified by a compile option (S22). When the power supply control level is level 0 indicating that power supply control is not conducted (S22, 0), the process directly ends.

When the power supply control level is level 1 indicating that power supply control is conducted only at the beginning of a function (S22, 1), level 1 power supply control code insert unit 43 inserts the power supply control code of level 1 (S23). The power supply control code insert process of level 1 will be described afterwards.

When the power supply control level is level 2 indicating that power supply control is carried out even during a function (S22, 2), level 1 power supply control code insert unit 43 inserts the power supply control code of level 1 (S24). Then, level 2 power supply control code insert unit 44 inserts the power supply control code of level 2 (S25). The power supply control code insert process of level 2 will be described afterwards.

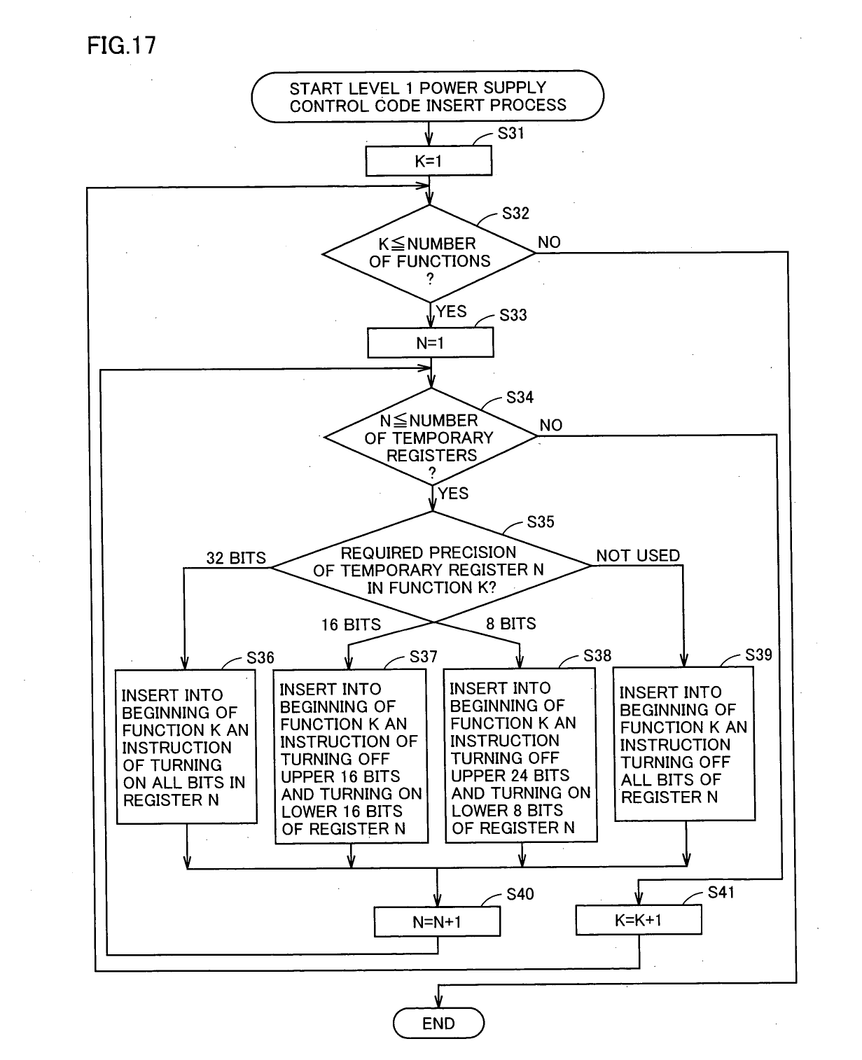

FIG. 17 is a flow chart to describe in detail the level 1 power supply control code insert process of steps S23 and S24 of FIG. 16. Level 1 power supply control code insert unit 43 inserts into a variable K the value of “1” as the initial value of the number of the function (S31).

Determination is made whether variable K is equal to or below the number of functions (S32). When variable K is greater than the number of functions (S32, NO), the process ends. When variable K is equal to or less than the number of functions (S32, YES), 1 is inserted as the initial value of the number of the temporary register for variable N (S33). A temporary register is a register that does not have to retain the value before and after a function call, i.e. a register that can be used arbitrarily within the function.

Then, determination is made whether variable N is equal to or below the number of temporary registers (S34). When variable N is larger than the number of temporary registers (S34, NO), variable K is incremented by 1 for the processing of the next function (S41). Then, control returns to step S32 to repeat the subsequent process.

When variable N is equal to or below the number of temporary registers (S34, YES), level 1 power supply control code insert unit 43 determines the precision required in temporary register N in function K (S35). When the required precision is 32 bits (S35, 32 bit), level 1 power supply control code insert unit 43 inserts into the beginning of function K an instruction indicating supply of power and clock to all the bits in temporary register N (S36). Then, variable N is incremented by one for the process of the next temporary register (S40). Then, control returns to step S34 to repeat the subsequent process. The required precision is determined from the type of variable to be assigned to the temporary register.

When the required precision is 16 bits (S35, 16 bits), level 1 power supply control code insert unit 43 inserts into the beginning of function K an instruction indicating that supply of power and clock to the upper 16 bits in the temporary register is suppressed and supply of power and clock to the lower 16 bits of the temporary register is effected (S37). Variable N is incremented by one to carry out the process of the next temporary register (S40). Then, control returns to step S34 to repeat the subsequent process.

When the required precision is 8 bits (S35, 8 bits), level 1 power supply control code insert unit 43 inserts into the beginning of function K an instruction indicating that supply of power and clock to the upper 24 bits in the temporary register is suppressed and supply of power and clock to the lower 8 bits in the temporary register is effected (S38). Variable N is incremented by 1 to carry out the next temporary register process (S40). Then, control returns to step S34 to repeat the subsequent process.

If temporary register N is not used (S35, not used), level 1 power supply control code insert unit 43 inserts into the beginning of function K an instruction indicating that supply of power and clock to all the bits in the temporary register is suppressed (S39). Variable N is incremented by 1 for the process of the next temporary register (S40). Then, control returns to step S34 to repeat the subsequent process.

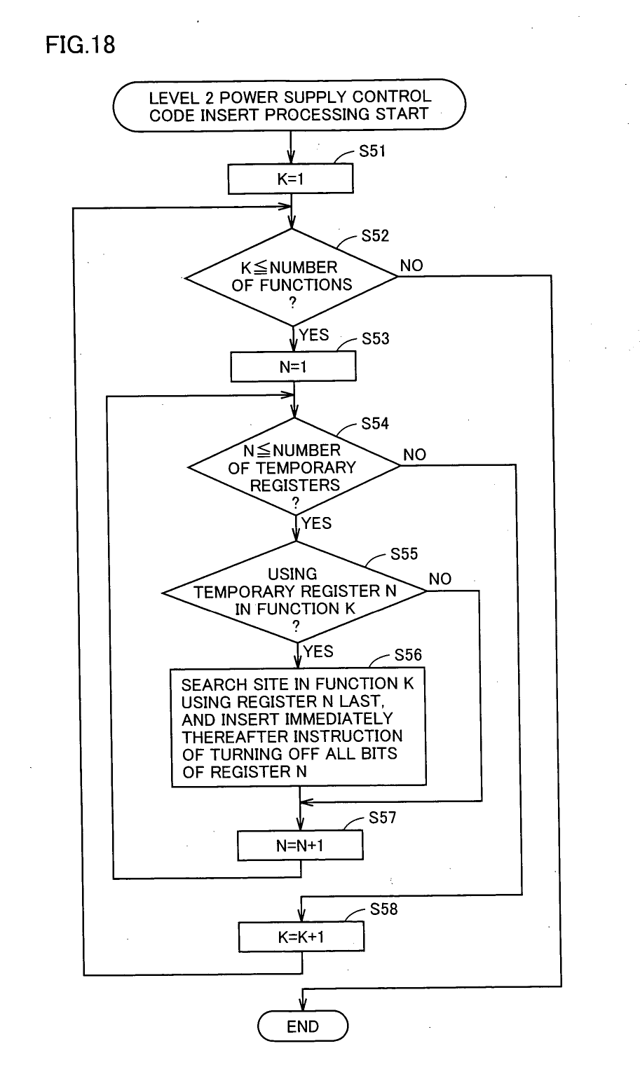

FIG. 18 is a flow chart to describe in detail level 2 power supply control code insert process of step S25 of FIG. 16. First, level 2 power supply control code insert unit 44 inserts 1 as the initial value of the function number of variable K (S51).

Determination is made whether variable K is equal to or less than the number of functions (S52). When variable K is larger than the number of functions (S52, NO), the process ends. When variable K is equal to or less than the number of functions (S52, YES), 1 is inserted as the initial value of the temporary register number in variable N (S53).

Then, determination is made whether variable N is equal to or less than the number of temporary registers (S54). When variable N is larger than the number of temporary registers (S54, NO), variable K is incremented by 1 for the process of the next function (S58). Then, control returns to step S52 to repeat the subsequent process.

When variable N is equal to or less than the number of temporary registers (S54, YES), determination is made whether temporary register N is used or not in function K (S55). When temporary register N is not used (S55, NO), variable N is incremented by 1 for the process of the next temporary register (S57). Then, control returns to step S54 to repeat the subsequent process.

When temporary register N is used (S55, YES), the site in function K where temporary register N is lastly used is identified, and an instruction is inserted immediately thereafter (S56). This instruction indicates that supply of power and clock to all the bits in temporary register N is suppressed. Then, variable N is incremented by 1 for the process of the next temporary register (S57). Then, control returns to step S54 to repeat the subsequent process.

According to the compiler of the present embodiment, the precision required in the temporary register in the function is identified, and supply of power and clock is controlled for each bit in the temporary register. Therefore, the program executed by MCU 1 described in the first embodiment can be compiled efficiently.

Since the power supply control is divided into two levels to control power supply and clock supply for each bit in the temporary register based on different ways, the versatility of the compiler can be further improved.

Although the present invention has been described and illustrated in detail, it is clearly understood that the same is by way of illustration and example only and is not to be taken by way of limitation, the spirit and scope of the present invention being limited only by the terms of the appended claims.

1. A microcontroller unit comprising:
a plurality of registers, and
an operation unit executing operation processing using said plurality of registers in accordance with a fetched instruction,
each of said plurality of registers including a plurality of data storage units storing data of a plurality of bits in a predetermined unit,
said microcontroller unit further comprising:
a precision storage unit storing required precision of data, and
a control unit for controlling whether to store data to be input into each of the plurality of data storage units in each of said plurality of registers in accordance with the precision of data stored in said precision storage unit.

2. The microcontroller unit according to claim 1, wherein said control unit includes a power supply control unit controlling power supply to each of said plurality of data storage units in accordance with the precision of data stored in said precision storage unit.

3. The microcontroller unit according to claim 2, further comprising a mode set unit to set one of a low power consumption mode and a normal mode,
wherein said power supply control unit provides control of power supply when a low power consumption mode is set in said mode set unit.

4. The microcontroller unit according to claim 2, wherein each of said plurality of data storage units outputs a value identical to a sign bit when power supply is suppressed.

5. The microcontroller unit according to claim 1, wherein said control unit includes a clock control unit controlling clock supply to each of said plurality of data storage units in accordance with the precision of data stored-in said precision storage unit.

6. The microcontroller unit according to claim 5, further comprising a mode set unit to set one of a low power consumption mode and a normal mode,
wherein said clock control unit provides clock control when a low power consumption mode is set in said mode set unit.

7. The microcontroller unit according to claim 5, wherein each of said plurality of data storage units outputs a value identical to the value of a sign bit when clock supply is suppressed.

8. The microcontroller unit according to claim 1, wherein said precision storage unit includes a plurality of precision storage units provided corresponding to said plurality of registers, each precision storage unit storing precision of data to be stored in a corresponding register.

9. The microcontroller unit according to claim 1, wherein said mode set unit sets the precision of data in said precision storage unit in accordance with a dedicated instruction setting a precision that is required.

10. The microcontroller unit according to claim 1, further comprising a precision determination unit receiving data stored in a register for determining data precision required for the register based on the received data and setting the data precision in said precision storage unit.

11. The microcontroller unit according to claim 1, further comprising a bus control unit controlling power supply and clock supply to control a bus in accordance with the precision of data stored by said precision storage unit in an access mode to a built-in memory or an external memory.

12. The microcontroller unit according to claim 1, wherein said plurality of registers are formed of a non-volatile memory.

13. A microcontroller unit comprising;
a plurality of registers, each storing data of a plurality of bits,
a plurality of precision storage units provided corresponding to said plurality of registers respectively, each precision storage unit storing information indicating precision of data stored in a corresponding register, and
an operation unit executing an operation using at least one of said plurality of registers in accordance with a fetched instruction, and executing said operation in a data width in accordance with the precision of data in a precision storage unit corresponding to said at least one register.

14. The microcontroller unit according to claim 13, wherein said operation unit comprises an arithmetic and logic unit receiving data of said at least one register to perform an operation, and
a power supply control unit controlling supply of power to be supplied to said arithmetic and logic unit in accordance with the precision of data stored in a precision storage unit corresponding to said at least one register.

15. The microcontroller unit according to claim 14, wherein said mode set unit sets one of a low power consumption mode and a normal mode in accordance with the dedicated instruction.

16. The microcontroller unit according to claim 13, wherein said operation unit includes an arithmetic and logic unit receiving data of said at least one register to perform an operation in synchronization with a clock, and
a clock control unit controlling supply of a clock to be supplied to said arithmetic and logic unit in accordance with the precision of data stored in a precision storage unit corresponding to said at least one register.

17. The microcontroller unit according to claim 13, further comprising a unit performing an operation, when there are at least two registers selected as operands among said plurality of registers, in a data width in accordance with the greatest precision of data among the precision of data stored in precision storage units corresponding to said at least two registers.

18. A compiler comprising:
a compile processing unit to carry out a normal compile process on a program, and
a code insert unit determining precision required for a register used in a function in the program compiled by said compile processing unit to insert an instruction code specifying a bit to which power is to be supplied and a bit to which power supply is suppressed in said register.

19. The compiler according to claim 18, wherein said code insert unit includes a first code insert unit determining precision required for a register used in a function in the program compiled by said compile processing unit to insert an instruction code specifying a bit to which power is to be supplied and a bit to which power supply is suppressed in said register into the beginning of said function.

20. The compiler according to claim 19, wherein said first code insert unit determines the precision required for said register from a type of variable assigned to said register.

21. The compiler according to claim 19, wherein said code insert unit further includes a second code insert unit searching for a site in said function where said register is lastly used, and inserting an instruction code immediately after said site, said inserted instruction code designating suppression of power supply to all bits in said register.

22. The compiler according to claim 21, wherein said compiler further comprises a determination unit determining, based on a compile option, as to which of said first code insert unit and said second code insert unit is used to insert an instruction code.
